(19) United States
(12) Patent Application Publication
(10) Pub. No.: US 2026/0249579 A1
(43) Pub. Date: Aug. 27, 2026

(54) FILLING APPARATUS FOR A ROTARY PRESS AS WELL AS A ROTARY PRESS

(71) Applicant: Fette Compacting GmbH, Schwarzenbek (DE)

(72) Inventors: Lasse TOMSETT, Hamburg (DE); Sven Kolbe, Büchen (DE); Antje Weddingfeld, Büchen (DE); Marcel Issmer, Lüneburg (DE)

(73) Assignee: Fette Compacting GmbH, (omitted)

(21) Appl. No.: 19/449,658

(22) Filed: Jan. 15, 2026

(30) Foreign Application Priority Data
Jan. 15, 2025 (DE) 10 2025 101 267.9

(51) Int. Cl. B30B 15/30

(52) U.S. Cl. CPC B30B 15/304

(57) ABSTRACT

A filling apparatus for a rotary press that is rotationally driven by a rotary drive includes a housing fixedly positioned above the die plate and defining a first chamber. A first wheel is positioned in the first chamber and configured to be driven by the rotary drive to fill the plurality of cavities with powder material located in the first chamber. A gearbox is positioned in a gearbox housing and coupled to the rotary drive and configured to transmit a rotational movement of the rotary drive to the first wheel. A gearbox coupling is positioned on the gearbox housing and an intermediate bearing is positioned on the housing and configured for detachably mounting the gearbox housing. The intermediate bearing comprises a bearing coupling corresponding to the gearbox coupling and configured to enable the gearbox housing to be releasably connected to the bearing coupling via the gearbox coupling.

### CROSS-REFERENCE TO RELATED APPLICATION

This application claims priority to, and the benefit of German Patent Application No. 102025101267.9, filed on Jan. 15, 2025. The contents of said application are hereby incorporated by reference.

### TECHNOLOGICAL FIELD

The following disclosure relates to a filling apparatus for a rotary press, in which, by means of the filling apparatus, powder material filled into cavities of a die plate of the rotary press that is driven in rotation is pressed into pellets by upper and lower pressing punches assigned to the cavities. The filling apparatus comprises a filling apparatus housing disposed in a stationary manner above the die plate during operation of the rotary press, in which housing a first filling chamber is formed. A first filling wheel is disposed in the first filling chamber and is rotatably drivable by a rotary drive such that powder material located in the first filling chamber is filled from the first filling chamber into the cavities of the die plate. The filling apparatus further has a gearbox that can be coupled to the rotary drive for transmitting a rotational movement of the rotary drive to the first filling wheel.

The following disclosure further relates to a rotary press, comprising a rotor that can be rotated by means of a rotary drive, wherein the rotor has an upper punch guide for upper pressing punches and a lower punch guide for lower pressing punches as well as a die plate defining a plurality of cavities and disposed between the punch guides. The pressing punches interact with the plurality of cavities of the die plate. A filling apparatus, by means of which powder material to be pressed is filled into the plurality of cavities of the die plate. The rotary press comprises a compression apparatus with an upper compression unit and a lower compression unit, which, during operation, interact with the upper pressing punches and with the lower pressing punches to press the powder material in the plurality of cavities of the die plate to form pellets. The rotary press further includes an ejection device for ejecting pellets produced in the rotary press. The filling apparatus includes a filling apparatus housing disposed in a stationary manner above the die plate during operation of the rotary press. A first filling chamber is formed in the filling apparatus housing and a first filling wheel is disposed in the first filling chamber and is rotatably driven by a rotary drive, such that powder material located in the first filling chamber is filled from the first filling chamber into the plurality of cavities of the die plate. The filling apparatus further has a gearbox that can be coupled to the rotary drive for transmitting a rotational movement of the rotary drive to the first filling wheel.

### BACKGROUND

In rotary tablet presses, a large number of upper and lower pressing punches are generally provided which are in each case assigned to one cavity of a die plate in pairs. During operation of the rotary press, the upper and lower pressing punches rotate together with the die plate, wherein their axial movement is controlled by means of control cams and is guided by means of upper and lower punch guides. During the course of the rotation, the die plate travels through various apparatuses of the rotary press, namely a filling apparatus, in which powder material to be pressed is guided into the cavities of the die plate, and a compression apparatus, in which the upper and lower pressing punches are typically pressed into the cavities by means of upper and lower compression rolls in order to press the powder material into pellets, such as tablets. Subsequent to the compression apparatus, the upper pressing punches are guided upward out of the cavities and the pellets generated in the cavities are pushed by the lower pressing punches onto the upper side of the die plate. Such rotary presses further comprise an ejection device for ejecting pellets produced in the rotary press. The ejection device can also comprise a scraper device for scraping off the pellets ejected by the lower pressing punches onto the upper side of the die plate after the pressing process. The scraper device can comprise a scraper channel which is disposed at least in portions above the die plate and conducts the pellets ejected onto the upper side of the die plate from the die plate, which rotates under the scraper channel, to a first pellet discharge chute. The first pellet discharge chute can be, for example, a discharge chute for pellets that are identified as good.

Filling apparatuses used in such rotary presses often have a plurality of filling wheels, which are driven by a common rotary drive. For this purpose, a gearbox is provided for transmitting the rotational movement of the rotary drive to the filling wheels. The filling wheels are generally each disposed in a filling chamber. For example, in three-chamber filling apparatuses, two filling chambers, each with one filling wheel, may be disposed side by side. A third chamber, in particular a distribution chamber, may be provided above the filling chambers. A likewise distribution wheel that is driven in rotation may be disposed in said distribution chamber. The function of the distribution wheel is to uniformly distribute powder material supplied, for example, via a hopper, into the filling chambers. The function of the filling wheels in the filling chambers is intended to be that of ensuring uniform filling of the powder material from the filling chamber into the cavities of the die plate.

In known filling apparatuses, the gearbox for transmitting a rotational movement of the rotary drive to the filling wheels or else to the distribution wheel is mounted on the filling apparatus. The gearbox comprises a series of gearbox components, in particular spur gears, shafts, and further standard parts, and has a significant weight. In order to dismount the filling apparatus from the rotary press, the filling apparatus must be removed together with the gearbox. Due to the limited space available and due to the large weight of the filling apparatus with the gearbox of typically more than 15 kg, this is only possible with great physical effort on the part of an operator. A standard occupational safety limit value for the weight of a component to be moved manually is regularly exceeded. The filling apparatus may need to be dismounted, for example, for a change between different operating modes of the rotary press, for example for conversion between single-layer and multilayer operation for producing single-layer or multilayer tablets. An adaptation of the rotary press to different operating modes is only possible in the prior art with considerable effort.

Proceeding from the prior art described above, the object of the invention is therefore to provide a filling apparatus and a rotary press of the type mentioned at the outset with which conversion of the rotary press for different operating modes is possible in a flexible and simple manner.

### SUMMARY

For a filling apparatus of the type mentioned at the outset, the invention achieves the object in that the gearbox is disposed in a gearbox housing. a gearbox coupling is disposed on the gearbox housing, in that an intermediate bearing for detachably mounting the gearbox housing is disposed on the filling apparatus housing. the intermediate bearing has a bearing coupling corresponding to the gearbox coupling, such that the gearbox housing can be releasably connected to the bearing coupling via the gearbox coupling.

For a rotary press of the type mentioned at the outset, the invention achieves the object in that the gearbox is disposed in a gearbox housing, wherein a gearbox coupling is disposed on the gearbox housing, in that an intermediate bearing for detachably mounting the gearbox housing is disposed on the filling apparatus housing, and in that the intermediate bearing has a bearing coupling corresponding to the gearbox coupling, such that the gearbox housing can be releasably connected to the bearing coupling via the gearbox coupling.

The basic structure of the filling apparatus and rotary press, which form the subject matter of the present invention, was explained at the outset. As explained, the upper and lower punch guides guide the pressing punches during their axial movement. The punch heads interact with control cams that move the pressing punches in the axial direction, in particular towards and away from each other, as they rotate with the rotor. The control cams are typically made up of multiple control cam elements. They can accommodate the punch heads in corresponding guide sockets or rest only against a mirror surface of the punch heads. The compression apparatus typically comprises an upper compression roll and a lower compression roll, which interact with the punch heads of the upper and lower pressing punches, respectively. Multiple compression apparatuses of this type can also be provided, for example pre-compression apparatuses and main compression apparatuses. The ejector cam, as part of the control cams, moves the lower pressing punches upward in their respective cavities after the pellets have been generated, such that the pellets reach the upper side of the die plate, from where they are conveyed to the first pellet discharge chute via a scraper channel, for example. The pellets can, in particular, be tablets. Accordingly, the rotary press can be a rotary tablet press. The tablets can be pharmaceutical tablets, for example.

In some embodiments, the filling apparatus has a first filling chamber with an inlet via which powder material to be pressed in the rotary press is supplied, for example via a feed hopper. The inlet may, for example, be formed on the upper side of the first filling chamber. The first filling wheel, which is disposed in the first filling chamber and is driven in rotation by the rotary drive, loosens the powder material in the first filling chamber and prevents bridging or other undesired powder accumulations, for example in dead spaces. The first filling chamber further has an outlet, which may be formed on the lower side of the first filling chamber, for example. Powder material falls through said outlet due to gravity, optionally assisted by the first filling wheel and optionally by further effects, such as suction/negative-pressure or centrifugal effects, into the cavities rotating with the die plate beneath the outlet. Subsequently, the powder material in the cavities is pressed into pellets by the upper and lower pressing punches. If, as explained below, further filling chambers are provided, these can likewise have such an inlet and/or outlet. However, it is also possible to use a common inlet and/or a common outlet with the first filling chamber. This also applies to an optionally provided distribution chamber. The first filling wheel and/or optionally further provided filling wheels, as well as an optionally provided distribution wheel, may each have agitator blades extending from a central region. The agitator blades may extend in a radial direction or be designed to be curved.

In some embodiments, the filling apparatus comprises a gearbox, which transmits a rotational movement of the rotary drive to the first filling wheel. The gearbox generally comprises a series of components that are disposed in the gearbox housing. These components comprise, for example, spur gears, shafts, and other standard parts. The spur gears and shafts are, in the assembled state, connected on the one hand to the rotary drive, for example to an output shaft of the rotary drive, and on the other hand to the first filling wheel, for example to a drive shaft of the first filling wheel. The gearbox can step up or else step down a rotational speed of the rotary drive to a different rotational speed of the first filling wheel. In the case of multiple driven filling and/or distribution wheels, the gearbox can also provide different rotational speeds for different filling wheels or else distribution wheels. For this purpose, the gearbox is connected, for example, to drive shafts of the filling wheels or else the distribution wheels.

In some embodiments, the gearbox is disposed in a gearbox housing, on which a gearbox coupling is disposed. An intermediate bearing is disposed on the filling apparatus housing for releasably or else removably mounting the gearbox housing. The intermediate bearing has a bearing coupling corresponding to the gearbox coupling, such that the gearbox housing can be releasably connected to the bearing coupling via the gearbox coupling. According to the invention, an intermediate bearing is provided between the filling apparatus housing and the gearbox or rather the gearbox housing, by means of which the gearbox with the gearbox housing can, by releasing the coupling between the bearing coupling and the gearbox coupling, be released, in particular lifted off, from the filling apparatus housing in a simple manner as an overall component or rather as a module. By releasably mounting the gearbox via the intermediate bearing, the gearbox can be released as a whole from the filling apparatus housing in a simple manner, such that the filling apparatus, after the gearbox housing has been lifted off, can be dismounted from the rotary press and mounted again in a simple manner. In the state of the gearbox dismounted from the filling apparatus housing, the filling apparatus housing can be removed from the rotary press in a simple manner without the gearbox, for example for a change of operating mode or for maintenance or repair. Due to the fact that, unlike in the prior art, it is not necessary to remove the filling apparatus housing together with the gearbox fixedly mounted thereto, the component to be removed, in this case the filling apparatus housing with the components disposed therein, is lighter and smaller, such that mounting and dismounting can be performed manually by an operator in a simple manner and in compliance with occupational safety guidelines.

In some embodiments, the intermediate bearing may in each case have one bearing or else bearing package for one filling wheel or one distribution wheel. For example, two bearings may be provided per wheel. The bearings are coupled to the gearbox via the bearing coupling. The bearing coupling and/or the gearbox coupling can have integrated replaceable wear parts. The invention can be used for different filling apparatuses, for example single-chamber, two-chamber, or three-chamber filling apparatuses. By virtue of the simplified dismounting and mounting of the filling apparatus as compared with the prior art, without the need to dismount or else mount the gearbox together with the filling apparatus, the rotary press can be adapted to different operating modes in a simple and flexible manner. The filling apparatus can be dismounted and mounted in a simple manner for repair or maintenance purposes as well. A changeover, for example between counter-rotating and co-rotating operation, can moreover be quickly realized by means of a changeover gearbox, wherein no elaborate gearbox conversion is required. Instead, the gearbox together with the gearbox housing can be removed and replaced by another gearbox. By dividing the assembly jointly formed in the prior art from the filling apparatus housing and the gearbox housing, with components disposed therein, into two separate or else readily separable components, simple dismounting and mounting is thus possible. In particular, in order to separate the gearbox from the filling apparatus housing, only the gearbox coupling needs to be released from the bearing coupling. For this purpose, for example, the releasing of a simple screw connection may be provided, for example of wing screws. No additional fasteners between the gearbox housing and the filling apparatus housing are required. In particular, it is possible that the gearbox housing is merely placed onto the filling apparatus housing and can accordingly be lifted upward off same without further dismounting operations. Improved accessibility and cleanability are also ensured with a view to containment conditions of containment rotary tablet presses as well, in particular because regions between the gearbox housing and the filling apparatus housing are also more accessible for cleaning than in the prior art. The installation and removal of the filling apparatus housing or else of the gearbox housing is possible under containment conditions. Accordingly, the present invention is particularly suitable for containment rotary tablet presses, as explained below. The components of the filling apparatus, in particular the filling apparatus housing and the removable gearbox housing, as well as, where applicable, further components provided as explained below, may accordingly be configured to be washable.

According to one embodiment, it may be provided that a second filling chamber is additionally formed in the filling apparatus housing, in which chamber a second filling wheel that can be driven in rotation by the rotary drive is disposed, wherein the gearbox also transmits a rotational movement of the rotary drive to the second filling wheel. According to a further embodiment, it may be provided that a distribution chamber is formed in the filling apparatus housing above the first and/or second filling chamber, in which distribution chamber a distribution wheel that can be driven in rotation by the rotary drive is disposed, wherein the gearbox also transmits a rotational movement of the rotary drive to the distribution wheel. In the filling apparatus housing, an intermediate plate disposed above the first and/or second filling chamber may be provided, which intermediate plate, together with a filling apparatus housing cover, delimits the distribution chamber. The second filling wheel may, for example, be a dosing wheel disposed upstream of the first filling wheel in the direction of rotation of the die plate. The second filling chamber may accordingly be a dosing chamber. As already explained, different rotational speeds of some or all of the filling wheels or else distribution wheels can be realized via the gearbox.

For particularly simple and secure mounting and dismounting, and for transmitting the rotational movement of the rotary drive to the first filling wheel and optionally further filling wheels or else distribution wheels, without the need for additional fastening means, the gearbox housing may be connectable in a form-fitting manner to the bearing coupling via the gearbox coupling.

According to a further embodiment, it may be provided that the bearing coupling has at least one self-aligning bearing shaft and the gearbox coupling has at least one shaft seat that receives the at least one bearing shaft in a state connected to the bearing coupling, or that the gearbox coupling has at least one self-aligning gearbox shaft and the bearing coupling has at least one shaft seat that receives the at least one gearbox shaft in a state connected to the gearbox coupling. Due to the fact that the coupling comprises at least one self-aligning shaft, a simpler assembly of the gearbox housing with the filling apparatus housing is achieved, since precise alignment of the couplings relative to one another prior to assembly of the gearbox housing can be dispensed with. If a plurality of filling wheels that are driven in rotation or else distribution wheels are provided, at least one bearing shaft or else at least one gearbox shaft may be provided for each filling wheel or else distribution wheel. These can have, for example at a portion received in the respective shaft seat, a non-rotationally symmetrical shape, wherein the shaft seat can have a complementary shape for establishing a form-fitting connection in the direction of rotation. The self-alignment of the bearing shaft or else gearbox shaft may be realized by an arrangement of the respective shaft with play perpendicular to the longitudinal axis thereof. The bearing shaft or else gearbox shaft can be disposed in the shaft seat by simple insertion therein. This facilitates mounting and dismounting.

According to a further embodiment, a stabilizing element can be provided for holding the at least one bearing shaft or the at least one gearbox shaft. The stabilizing element may comprise a carrier element that holds the at least one bearing shaft and is disposed on the filling apparatus housing. It is also possible for the stabilizing element to comprise a carrier element that holds the at least one gearbox shaft and is disposed on the gearbox housing. The carrier element may, for example, be designed to be V-shaped, T-shaped, or triangular. The stabilizing element may have a socket or a through-opening or else passage, in which the at least one bearing shaft or else gearbox shaft is received. The stabilizing element on the one hand holds the bearings and on the other hand absorbs the forces acting on the bearings during operation. It can, in the presence of multiple bearing shafts or else multiple gearbox shafts, hold all of the bearing shafts or else all of the gearbox shafts and, for this purpose, have, for example, corresponding sockets or through-openings or else passages. It may, for example, be formed by a steel or aluminum support.

A removal device may further be disposed on the gearbox housing, for removing the gearbox housing from the filling apparatus housing. For example, it is possible that the gearbox housing can be lifted off of the filling apparatus housing by means of the removal device. The removal device may have at least one retaining lug, for example a plurality of retaining lugs, for lifting off the gearbox housing. The at least one retaining lug may be designed, for example, in a mushroom-shaped or hook-shaped manner. Furthermore, the removal device may comprise a button holder and/or a magnetic holder and/or a pressure bolt. The removal device can facilitate lifting off of the gearbox housing from the filling apparatus housing, for example by an operator.

According to a further embodiment, a support element that can be fastened to the rotary press may further be provided, on which the gearbox housing, in a state lifted off of the filling apparatus housing, can be held by the removal device. The support element may, for example, be formed by a retaining plate, which may, for example, be connected to a cam carrier for carrying control cams of the rotary press. The gearbox housing can then, during dismounting, initially be held or else “parked” on the support element. In particular, the above-mentioned embodiments of the removal device with a button holder or else a magnetic holder serve for holding the gearbox housing on the support element. The support element may have a holding device corresponding to the removal device, for example a socket for a button holder or a magnetic holding device for magnetically holding the magnetic holder of the removal device. If the removal device comprises a pressure bolt, this can simplify lifting off of the gearbox housing from the filling apparatus housing. In the state of the gearbox housing held on the support element, the filling apparatus housing can be dismounted in a simple manner. Subsequently, the gearbox housing can also be removed from the rotary press.

As already explained, the rotary press may be a containment rotary tablet press. Such containment rotary tablet presses are used, in particular, in the pharmaceutical field, for example for processing health-critical active substances or hormones. Containment presses have particular protective measures to prevent substances processed in the rotary press from reaching the environment of the rotary press, where they may pose a health hazard to operators. In such rotary presses, particular requirements exist with respect to the limited accessibility of the press housing of the rotary press as well as the cleanability of the components of the rotary press. These requirements can be fulfilled particularly well by the embodiment according to the invention of the filling apparatus with a removable gearbox.

The filling apparatus used in the rotary press according to the invention can, in all of its embodiments, be designed in the manner according to the invention described above and below.

In order to remove the filling apparatus according to the invention with a gearbox from a rotary press, the following procedure may be carried out: prior to removal, the filling apparatus is positioned in the rotary press with blade wheels oriented toward the die plate and, for example, a feed hopper oriented toward a powder feed. The removable gearbox block with the gearbox housing often cannot readily be lifted off past the feed hopper in this aligned position. In order to dismount the filling apparatus, the gearbox housing can first be lifted off of the filling apparatus housing by releasing the gearbox coupling from the bearing coupling of the intermediate bearing and can, for example, be parked on a support element by means of the removal device. Subsequently, the remaining part of the filling apparatus, namely the filling apparatus housing, can be manually removed from the rotary press by an operator. The gearbox housing can subsequently, in a second dismounting step, be released from the support element fastened, for example, to the cam carrier of the rotary press and, with the filling apparatus housing dismounted, be readily removed from the rotary press. A subsequent reassembly of the filling apparatus with the gearbox can be carried out in reverse order.

### BRIEF DESCRIPTION OF THE DRAWINGS

An exemplary embodiment of the invention is explained below in greater detail based on figures, in which:

FIG. 1 illustrates an unrolled side view of an embodiment of a rotary press, according to aspects of the disclosure;

FIG. 2 illustrates a top view of the embodiment of FIG. 1 showing an embodiment of a filling apparatus, according to aspects of the disclosure;

FIG. 3 illustrates a perspective view of the embodiment of the filling apparatus of FIG. 2, according to aspects of the disclosure;

FIG. 4 illustrates a bottom view of the embodiment of the filling apparatus of FIG. 2, according to aspects of the disclosure;

FIG. 5 illustrates a perspective view of the embodiment of FIG. 3 with the gearbox dismounted, according to aspects of the disclosure;

FIG. 6 illustrates a top perspective view of the gearbox of the filling apparatus of FIGS. 2-4, according to aspect of the disclosure; and

FIG. 7 illustrates a perspective bottom view of the gearbox of FIG. 6, according to aspects of the disclosure.

If not otherwise specified, the same reference signs denote the same subject matter in the figures.

### DETAILED DESCRIPTION OF THE INVENTION

The rotary press according to the invention shown in FIG. 1 is a rotary press for producing tablets, and in which powdered material is pressed to form tablets. The rotor of the rotary press is driven in rotation by a rotary drive and comprises a die plate 10 which has a plurality of cavities 12. The plurality of cavities 12 can be formed, for example, by bores in the die plate 10. The rotor further comprises a plurality of upper pressing punches 14 and lower pressing punches 16 which revolve synchronously with the die plate 10. The upper pressing punches 14 are axially guided in an upper punch guide 18 and the lower pressing punches 16 are axially guided in a lower punch guide 20. The axial movement of the upper pressing punches 14 and lower pressing punches 16 in the course of the rotation of the rotor is controlled by upper control cam elements 22 and lower control cam elements 24. The control cam elements 22, 24 are held on a cam carrier of the rotary press. Furthermore, a filling apparatus 26, shown only very schematically in FIG. 1, is provided, which has a feed hopper 28 as well as a first filling chamber 30 and a second filling chamber 31, wherein the feed hopper 28 is connected to a filling tube 32. In this way, in the present example, powdered material arrives from the feed hopper 28 via the filling tube 32 into the filling chambers 30, 31, for example due to gravity, and from there via an outlet provided on the lower side of the filling chamber 30, 31 into the cavities 12 of the die plate 10, again for example due to gravity.

The rotary press further comprises a compression apparatus 34. The compression apparatus 34 comprises a pre-compression apparatus with an upper pre-compression roller 36 held on an upper holder 35 and a lower pre-compression roller 38 held on a lower holder 37, as well as a main compression apparatus with an upper pressure roller 40 held on an upper holder 39 and a lower pressure roller 42 held on a lower holder 41. In addition, the rotary press comprises an ejection device 44 with a stripper 46. The stripper 46 scrapes tablets 48, which are conveyed onto the upper side of the die plate 10 by the lower pressing punches 16, from the die plate 10 and conveys the tablets 48 through the stripper 46 to a first pellet discharge chute 50. The stripper 46 may be, for example, crescent-shaped. Furthermore, the rotary press comprises a control apparatus 52 for controlling the operation of the rotary press. The rotary press further comprises a second pellet discharge chute, not shown in detail in FIG. 1, which, in the direction of rotation of the die plate 10, is disposed upstream of the first pellet discharge chute 50 and may, for example, be disposed parallel thereto.

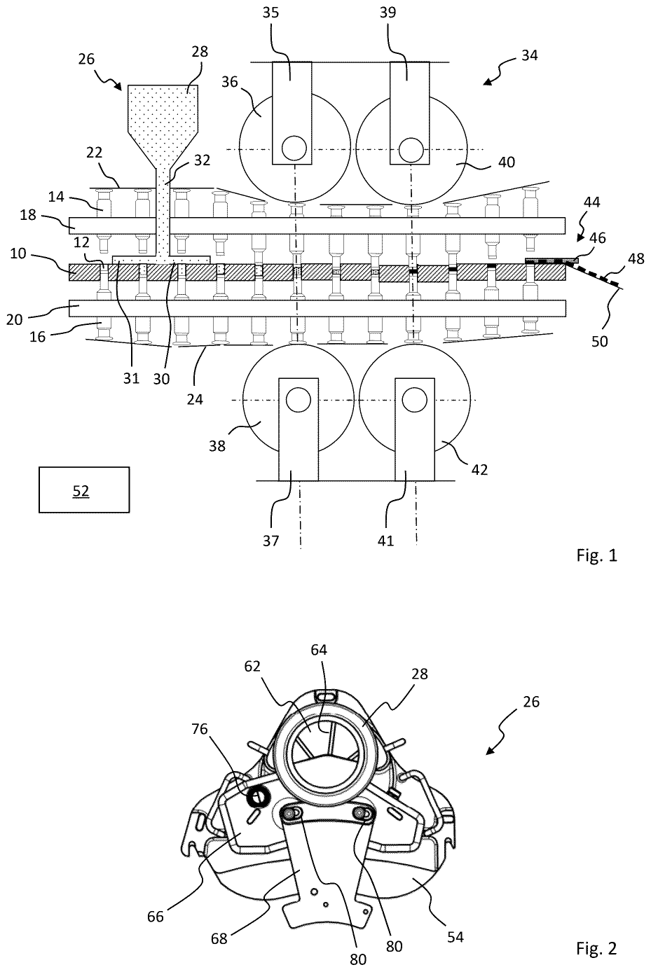

With reference to FIGS. 2 to 4, the structure of the filling apparatus 26 shown merely in a highly schematic manner in FIG. 1 will be explained in greater detail. The filling apparatus 26 comprises a filling apparatus housing 54 in which the first filling chamber 30 and the second filling chamber 31 are formed adjacent to one another. A first filling wheel 56 that can be driven in rotation is disposed in the first filling chamber 30, and a second filling wheel 58 that can likewise be driven in rotation is disposed in the second filling chamber 31, which second filling wheel may be, for example, a dosing wheel. In particular, it can be seen in FIG. 4 that the filling apparatus housing 54 has, on its lower side, an elongate cutout 60 which forms the outlet of the first filling chamber 30 and of the second filling chamber 31. In the mounted state of the filling apparatus 26, the cavities 12 of the die plate 10 are rotated beneath the curved outlet 60, such that powder material from the filling chambers 30, 31 can enter the cavities 12.

In particular, FIG. 2 shows that a distribution chamber 62 is located below the feed hopper 28 and disposed above the filling chambers 30, 31, and a distribution wheel 64 is disposed in said distribution chamber so as to be drivable in rotation. The distribution chamber 62 and, together therewith, the distribution wheel 64 are disposed in a laterally offset manner above the first and second filling chamber 30, 31, such that the distribution wheel 64, in the course of its rotation, partially sweeps over the first and second filling wheel 56, 58. An outlet is disposed on the lower side of the distribution chamber 62, via which powder material supplied by the feed hopper 28, conveyed by the distribution wheel 64, reaches the first and second filling chamber 30, 31. The filling wheels 56, 58 as well as the distribution wheel 64 each have agitator blades extending in the radial direction. The agitator blades may also be designed to be curved. The supply hopper 28 can be connected on its upper side to a feed for powder material to be pressed in the rotary press.

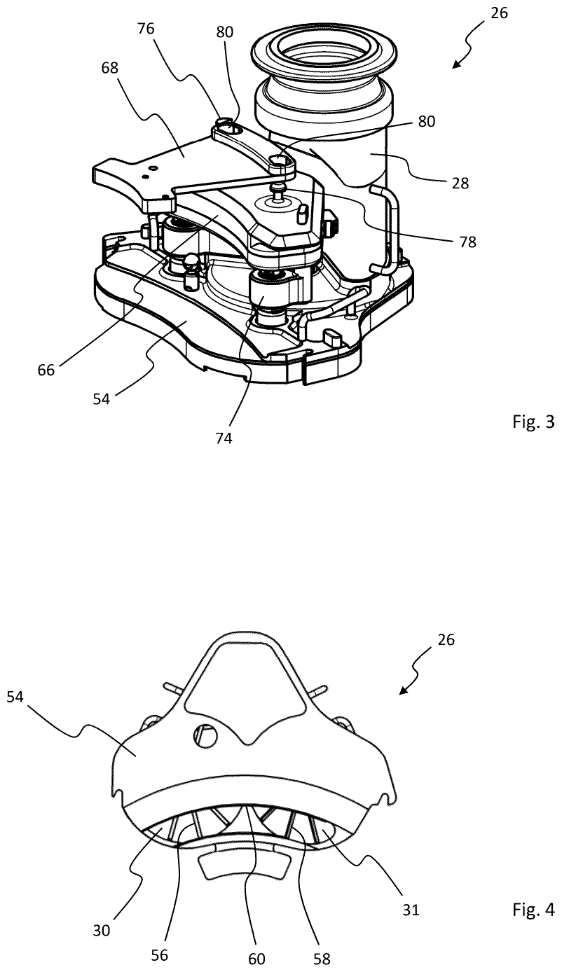

As can be seen, in particular, in FIGS. 2 and 3, in the assembled state, a gearbox housing 66 is disposed on the filling apparatus housing 54, in which gearbox housing a gearbox is disposed for transmitting a rotational movement of a rotary drive to the filling wheels 56, 58 and the distribution wheel 64. The rotary drive is not shown in FIGS. 2 to 4 for illustrative purposes. In particular in FIGS. 2 and 3, furthermore, a support element 68 designed as a retaining plate 68 can be seen, which may, for example, be fastened to a cam carrier of the rotary press.

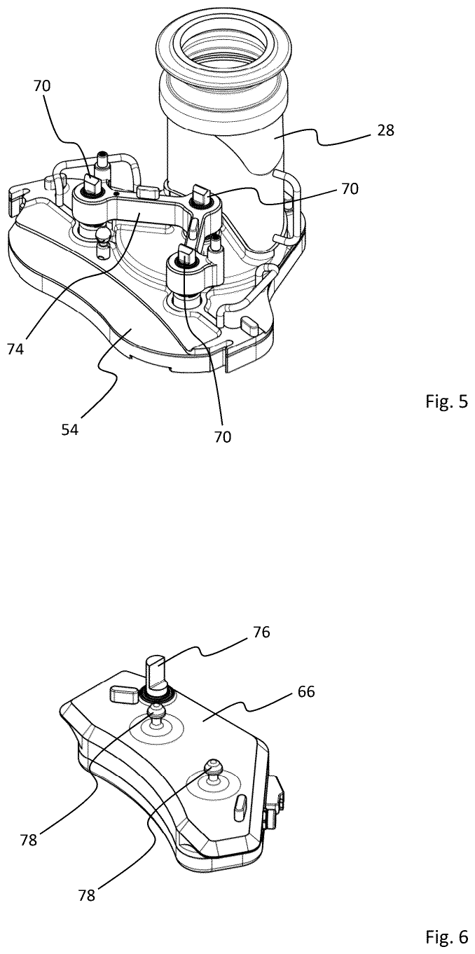

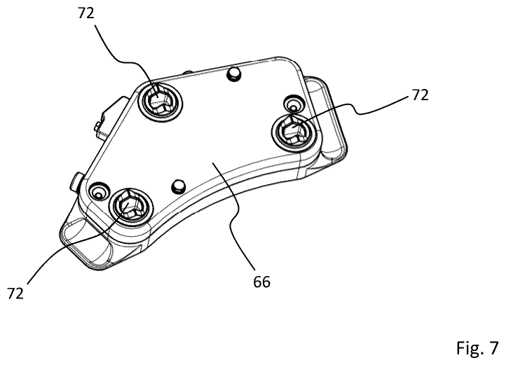

In FIG. 5, for illustrating the intermediate bearing provided according to the invention, the filling apparatus is shown without the gearbox housing 66 and without the retaining plate 68. In the present example, three self-aligning bearing shafts 70 of a bearing coupling of an intermediate bearing for the gearbox are disposed on the filling apparatus housing 54. The self-aligning bearing shafts 70 may be mounted on the filling apparatus housing 54 with play perpendicular to their longitudinal axis, which extends vertically in FIG. 5, in order to realize the self-aligning function. As can be seen in FIG. 5, the bearing shafts 70 have, at their end remote from the filling apparatus housing 54, a non-rotationally symmetrical cross-section. It can further be seen in FIG. 7 that the gearbox housing 66 has, on its lower side, shaft seats 72 which are shaped complementarily to the bearing shafts 70 and in which the bearing shafts 70, in the state of the gearbox housing 66 mounted on the filling apparatus housing 54, are received in a form-fitting manner and thus supported. The shaft seats 72 form a gearbox coupling of the gearbox housing 66.

In FIG. 5, a stabilizing element 74 holding the bearing shafts 70 and disposed on the filling apparatus housing 54 can be seen. The stabilizing element 74 may be designed as a V-shaped, T-shaped, or triangular carrier element and serves for holding the bearing shafts 70 and for absorbing forces acting on the bearing shafts 70. Each of the bearing shafts 70 serves to drive one of the filling wheels 56, 58 or else the distribution wheel 64.

In the view of FIG. 6 of the gearbox housing 66, on the one hand, a gearbox drive shaft 76 can be seen, which, during operation, is engaged in a form-fitting manner with an output shaft of the rotary drive. To this end, the end of the gearbox drive shaft 76 remote from the gearbox housing 66 has a non-rotationally symmetrical cross-section. The output shaft may have a complementary cross-section. The rotational movement of the rotary drive, transmitted via the output shaft of the rotary drive, is transmitted via the gearbox drive shaft 76 to the gearbox components disposed in the gearbox housing 66, in particular spur gears, and from these via the bearing shafts 70 to the filling wheels 56, 58 or else the distribution wheel 64.

In FIG. 6, it can further be seen that two retaining lugs 78 of a removal device of the gearbox housing 66 are disposed on the upper side of the gearbox housing 66. The mushroom-shaped retaining lugs 78 form a button holder that can be received and held in corresponding sockets 80 of the retaining plate 68. For this purpose, the gearbox housing 66 can be lifted upward off of the filling apparatus housing 54 from the position mounted on the filling apparatus housing 54 shown in FIG. 3, wherein the retaining lugs 78 are received in the retention sockets 80 of the retaining plate 68 and the gearbox with the gearbox housing 66 can be temporarily held or else parked. In the state of the gearbox lifted off of the filling apparatus housing 54, the filling apparatus together with the filling apparatus housing 54 can be dismounted and removed from its mounting position in the pressing chamber of the rotary press. Subsequently, the gearbox with the gearbox housing 66 can be detached from the retaining plate 68 by pulling the retaining lugs 78 downward out of the retention sockets 80 again. Due to the already dismounted filling apparatus housing 54, the gearbox with the gearbox housing 66 can subsequently also be manually removed from the pressing chamber of the rotary press in a simple manner. Reinstallation of the filling apparatus with the gearbox can be carried out in reverse order.

Alternatively or additionally, the retaining lugs 78 and the retention sockets 80 may be designed to be magnetic, such that the retaining lugs 78 are received in the retention sockets 80 in a simplified manner and the holding forces in the retention sockets 80 are increased. It is further conceivable that a pressure bolt is provided, which facilitates the movement of the gearbox housing 66 upward away from the filling apparatus housing 54.

List of reference signs

| | |
|---|---|
| 10 | Die plate |
| 12 | Cavities |
| 14 | Upper pressing punches |
| 16 | Lower pressing punches |
| 18 | Upper punch guide |
| 20 | Lower punch guide |
| 22 | Upper control cam elements |
| 24 | Lower control cam elements |
| 26 | Filling apparatus |
| 28 | Feed hopper |
| 30 | First filling chamber |
| 31 | Second filling chamber |
| 32 | Filling tube |
| 34 | Compression apparatus |
| 35 | Upper holder |
| 37 | Lower holders |
| 36 | Upper pre-compression roller |
| 38 | Lower pre-compression roller |
| 39 | Upper holder |
| 40 | Upper pressure roller |
| 41 | Lower holder |
| 42 | Lower pressure roller |
| 44 | Ejection device |
| 46 | Stripper |
| 48 | Tablets/pellets |
| 50 | Pellet discharge chute |
| 52 | Control apparatus |
| 54 | Filling apparatus housing |
| 56 | First filling wheel |
| 58 | Second filling wheel |
| 60 | Cutout |
| 62 | Distribution chamber |
| 64 | Distribution wheel |
| 66 | Gearbox housing |
| 68 | Support element |
| 70 | Bearing shafts |
| 72 | Shaft seats |
| 74 | Stabilizing element |
| 76 | Gearbox drive shaft |
| 78 | Retaining lugs |
| 80 | Retention sockets |

1. A filling apparatus for filling a powder material into cavities of a die plate of a rotary press that is rotationally driven by a rotary drive, comprising:
a filling apparatus housing fixedly positioned above the die plate during operation of the rotary press, wherein the filling apparatus housing defines a first filling chamber;
a first filling wheel is positioned in the first filling chamber and configured to be rotatably driven by the rotary drive of the rotary press, wherein powder material located in the first filling chamber is filled from the first filling chamber into the cavities of the die plate;
a gearbox positioned in a gearbox housing and coupled to the rotary drive and configured to transmit a rotational movement of the rotary drive to the first filling wheel;
a gearbox coupling positioned on the gearbox housing;
an intermediate bearing positioned on the filling apparatus housing and configured for detachably mounting the gearbox housing; and
wherein the intermediate bearing comprises a bearing coupling corresponding to the gearbox coupling to enable the gearbox housing to be releasably connected to the bearing coupling via the gearbox coupling.

2. The filling apparatus according to claim 1, wherein the filling apparatus housing further defines a second filling chamber, wherein a second filling wheel is positioned in the second filling chamber and is configured to be rotationally driven by the rotary drive, and wherein the gearbox is configured to transmit a rotational movement of the rotary drive to the second filling wheel.

3. The filling apparatus according to claim 2, wherein the filling apparatus housing defines a distribution chamber positioned above at least one of the first and second filling chambers, wherein a distribution wheel is positioned in the distribution chamber and configured to be rotationally driven by the rotary drive, and wherein the gearbox is configured to transmit a rotational movement of the rotary drive to the distribution wheel.

4. The filling apparatus according to claim 1, wherein that the gearbox housing is configured to be connectable in a form-fitting manner to the bearing coupling via the gearbox coupling.

5. The filling apparatus according to claim 1, wherein the bearing coupling comprises at least one self-aligning bearing shaft, and wherein the gearbox coupling comprises at least one shaft seat configured to receive the at least one self-aligning bearing shaft in a state connected to the bearing coupling.

6. The filling apparatus according to claim 1, wherein the gearbox coupling comprises at least one self-aligning gearbox shaft, and wherein the bearing coupling comprises at least one shaft seat configured to receive the at least one gearbox shaft in a state connected to the gearbox coupling.

7. The filling apparatus according to claim 5, further comprising a stabilizing element configured to hold one of the at least one self-aligning bearing shaft or the at least one gearbox shaft.

8. The filling apparatus according to claim 7, wherein the stabilizing element comprises a carrier element configured to hold the at least one self-aligning bearing shaft and is positioned on the filling apparatus housing.

9. The filling apparatus according to claim 7, wherein the stabilizing element comprises a carrier element that is configured to hold the at least one gearbox shaft and is positioned on the gearbox housing.

10. The filling apparatus according to claim 1, further comprising a removal device positioned on the gearbox housing and configured to remove the gearbox housing from the filling apparatus housing.

11. The filling apparatus according to claim 10, wherein the removal device comprises at least one retaining lug configured to lift off the gearbox housing.

12. The filling apparatus according to claim 11, wherein the removal device further comprises at least one of: (i) button holder; (ii) a magnetic holder; or (iii) a pressure bolt.

13. The filling apparatus according to claim 10, further comprising a support element configured to be fastened to the rotary press, wherein the gearbox housing, in a state lifted off of the filling apparatus housing, is configured to be held by the removal device.

14. A rotary press comprising:
a rotor that configured to be rotated by means of a rotary drive, wherein the rotor comprises,
an upper punch guide (18) for upper pressing punches (14), and
a lower punch guide (20) for lower pressing punches, and
a die plate defining a plurality of cavities and positioned between the punch guides, wherein the pressing punches are configured to interact with the plurality of cavities of the die plate;
a filling apparatus configured to fill the plurality of cavities with a powder material to be pressed, wherein the filling apparatus comprises,
a filling apparatus housing disposed in a stationary manner above the die plate during operation of the rotary press,
a first filling chamber is formed in the filling apparatus housing,
a first filling wheel is disposed in the first filling chamber and configured to be rotationally driven by the rotary drive so that the powder material located in the first filling chamber is filled from the first filling chamber into the plurality of cavities of the die plate,
a gearbox disposed in a gearbox housing and configured to be coupled to the rotary drive and to transmit a rotational movement of the rotary drive to the first filling wheel,
a gearbox coupling disposed on the gearbox housing, and
an intermediate bearing disposed on the filling apparatus housing and configured for detachably mounting the gearbox housing, wherein the intermediate bearing comprises a bearing coupling corresponding to the gearbox coupling, wherein the gearbox housing is configured to be releasably connected to the bearing coupling via the gearbox coupling;
a compression apparatus comprising an upper compression unit and a lower compression unit that are configured to interact with the upper pressing punches and with the lower pressing punches to press the powder material in the cavities of the die plate to form pellets; and
an ejection device configured to eject pellets produced in the rotary press.

15. The rotary press according to claim 14, wherein the rotary press is a containment rotary tablet press
